(19) United States
(12) Patent Application Publication
(10) Pub. No.: US 2002/0130561 A1
(43) Pub. Date: Sep. 19, 2002

(54) Moving coil motor and implementations in MEMS based optical switches

(76) Inventors: Viktoria A. Temesvary, Los Angeles, CA (US); Salleh Ismail, Moorpark, CA (US); Shuyun Wu, Arcadia, CA (US)

Correspondence Address: LIU & LIU LLP, 811 WEST SEVENTH STREET, SUITE 1100, LOS ANGELES, CA, 90017, US

(21) Appl. No.: 10/036,769

(22) Filed: Nov. 8, 2001

Related U.S. Application Data
(60) Provisional application No. 60/277,135, filed on Mar. 18, 2001.

(51) Int. Cl. H02K 41/00

(52) U.S. Cl. 310/12

(57) ABSTRACT

A moving coil motor has an axisymmetric magnetic field applied to the drive coils on the movable member of the motor. The movable member is suspended by springs. The moving coil motor may be configured in a MEMS format, with the movable member and its suspension springs fabricated from a mono-crystalline substance to improve structural integrity. MEMS based moving coil motors may be configured in an array. Sensors are provided to detect the relative spatial positions of the movable member. The movable member may include several tiers. In one application, the moving coil motor may be configured to support and drive a mirror surface on the movable member to form a galvanometer, optical switch, or other optical component. Singular moving coil motors may be configured in an optical cavity to facilitate the tuning of specific wavelengths while a number of moving coil motors may be configured to form an array of optical switches to facilitate switching in a multi-channel optical network.

### BACKGROUND OF THE INVENTION

1. Field of the Invention

This invention relates to moving coil motors, and particularly to moving coil motors in the format of micro-electro-mechanical system (“MEMS”).

2. Description of the Related Art

MEMS includes micro-electro-mechanical devices that are fabricated by “micromachining”, which involves carving a device out of a silicon wafer or other materials such as a slide of polymer or quartz, using topography based semiconductor manufacturing techniques (e.g., lithography, deposition, chemical and/or plasma etching, etc. processes). For example, moveable micromirrors may be implemented in the form of MEMS. One type of prior art MEMS based micromirrors use Lorentz forces to generate a torque to scan or oscillate the mirror. The mirror is pivotally supported by torsion bars along the rotation axis. A common use for such MEMS mirror devices is a galvanometer or optical scanning unit commonly used in storage and imaging technologies. One of the inherent problems with prior art MEMS based scanning mirrors is that they require a relatively large amount of electrical power or high voltages for a relatively small mirror displacement. Typically scanning mirrors operate at resonance frequency, and large static angular displacements are difficult or impossible to achieve over a fixed duration. High power consumption leads to higher heat build-up in the optical switch system, which adversely affects structural stability as a result of thermal expansion and induced stresses.

For example, the inventor considered the design of a gimbal structure based on the dual-axis MEMS based galvanometer described in U.S. Pat. No. 5,606,447. Such structure comprises a silicon substrate having a planar movable member supported by a dual-pivot torsion bar gimbal assembly. A primary drive coil is provided on an upper surface about the mirror. A secondary drive coil is on the outer gimbal frame. A number of permanent magnets are positioned above and below the movable member. The primary planar coil, when energized with current, interacts with the magnetic field inducing Lorentz forces that rotate the movable member in primarily one-axis of freedom. The direction and quantity of current flowing in the drive coil is controlled to variably control the displacement angle of the movable member. The Lorentz forces act against the torsion forces of the torsion bars. Because of the configuration and placement of the magnets and the design of the dual-pivot torsion bar gimbal structure, a relatively large amount of power is required for a relatively small displacement of the movable member. Further, the structure requires several pieces of magnet configured in a relatively complex 3D assembly structure that is more difficult to manufacture. It is noted that the permanent magnets are positioned relative to each other and to the drive coil in a manner such that there is an effective component of the permanent magnet field parallel to the drive coil in relation to each axis of rotation. Furthermore, the placement of the two tiers of permanent magnets substantially limits the range of angular movement of the device.

It is therefore desirable to design an efficient MEMS based moving coil motor that overcomes the deficiencies in the prior art and can be adapted easily and efficiently to optical switching, tuning, and attenuation functions (as opposed to a scanning function).

### SUMMARY OF THE INVENTION

The present invention overcomes the shortcomings of the prior art moving coil motors and enables new applications in the optical switching field. In one aspect of the present invention, an axisymmetric magnetic field is applied to the movable member of the moving coil motor, which has a magnetic axis that is substantially orthogonal to the nominal plane of the movable member. At least one electrical conductive element is fabricated on the movable member about the magnetic axis, such that the effective component of the axisymmetric magnetic field is in a generally radial direction with respect to the electrical conductive element(s). The electrical conductive elements are configured such that the current flowing through the electrical conductive elements interacts with the axisymmetric magnetic field to tilt or move the movable member in at least one degree of freedom. The present invention is applicable to moving coil motors configured for motions about one or more axes.

In another aspect of the present invention, the movable member of the moving coil motor is supported for tilting motion by suspending the movable member. The movable member is supported by a plurality of suspension springs, such as planar serpentine springs, to allow tilt in one or more axes. The suspension springs may be configured in a symmetrical or asymmetrical fashion about the movable member.

In a further aspect of the present invention, the moving coil motor is configured in a MEMS format. In particular, the movable member and its suspension are fabricated from a mono-crystalline substrate to improve structural integrity. MEMS based moving coil motors may be configured in an array fabricated on the same substrate or assembled from individual motors onto a common substrate. The MEMS based moving coil motor may be bulk fabricated using semiconductor element manufacturing techniques.

In one embodiment of the present invention, suspension springs (symmetrically or axisymmetrically) support the periphery of the movable member to a frame for tilting and/or vertical movement with respect to the nominal plane of the movable member. Electrical conductive members in the form of planar coils are placed (e.g., symmetrically or axisymmetrically, though not necessarily) on the movable member to function as the drive coils in the moving coil motor. The conductive members may be disposed outside the perimeter of a working surface, such as a mirror, and/or near the periphery of the movable member. Alternatively, the conductive member may be disposed below, or on the surface opposite the working surface, so as to allow more room for a larger working surface for a given form factor of the moving coil motor.

The frame may consist of one or more substantially parallel oriented substrates coupled by a spacing means to provide for support of the movable member and additionally to provide a second base member beneath the moveable member (and top frame member) on which to fabricate additional planar coils. The top frame member will typically be fabricated at the same time and during the same process as the movable member it supports. The spacing means and base member may be coupled to the top frame using a variety of semiconductor element manufacturing techniques such as solder ball bonding or a ball grid array (BGA).

A magnet means, such as an electromagnet, permanent magnet, or any ferromagnetic material, element, or assembly having a remnant magnetic field, is positioned with respect to the movable member with its magnetic axis substantially orthogonal to the nominal plane of the movable member, providing a generally radial axisymmetrical magnetic field with respect to the drive coils. As electrical current is applied selectively and differentially to the drive coils, Lorentz forces are created by the interaction of the electric current and the magnetic field of the permanent magnet, which angularly tilts or vertically translates (among other movements) the movable member. The movable member may be freely suspended by the suspension springs, or in addition supported on a pivot along the magnetic axis of the permanent magnet. The pivot limits the translational movement of the movable member towards the permanent magnet and may also function to limit in-plane motion if so desired. By supporting the movable member using suspension springs, the movable member can freely move in a variety of different fashions.

In another aspect of the present invention, sensors are provided to detect the relative positions of the movable member. Position sensing may be based on eddy current sensing or capacitance sensing. Alternatively, position sensing may be implemented in accordance with linear variable differential transformer (LVDT) principles. For example, position sensing may be implemented using complementary transmitter and receiver coils that are inductively coupled. A high frequency AC signal is sent through the transmitter coil and variations in the voltage drop induced in the receiver coil arising from changes in the relative positions between the transmitter and receiver coils are detected. Many different position sensing configurations are possible so long as inductively coupled coil sets are positioned on both the fixed frame and movable members of moving coil motor. The transmitter coils may be disposed on the movable member and the receiver coils may be disposed on an adjacent fixed member (either the top or the base portion of the fixed frame). Alternatively the receiver coils may be disposed on the movable member and the transmitter coils may be disposed on an adjacent fixed member (either the top or the base portion of the frame). The transmitter coils and receiver coils need not be mirror images of each other in order to provide for inductive coupling.

In one embodiment of a dual-die moving coil motor assembly, transmitter coils are fabricated on either the top or base of the movable member. The same coils on the movable member function as both the drive coils for the moving coil motor and the transmitter coils for position sensing. The drive/transmitter coils are inductively coupled to the receiver coils on the fixed frame. A high frequency AC signal is superimposed onto the DC control current to the drive coil. The positions of the movable member are determined based on the detection of the variations in voltage drop induced on the fixed receiver coils arising from changes in the relative positions (and therefore inductive coupling) between the drive/transmitter coils and the receiver coils.

Alternatively, the transmitter coils are positioned on either the top or base member of a fixed frame relative to the drive coils on the movable member. In this embodiment, the coils on the movable member function both as drive coils for the moving coil motor, and receiver coils for position sensing. The high frequency AC signal can be sent through the windings of the transmitter coils, and the drive coils would be used to sense the tilt positions by its induced voltage drop. Due to its high frequency, this AC signal on the drive coil will not interfere with the static actuation or the device dynamics.

In one embodiment of the present invention, ‘flip chip’ semiconductor element manufacturing techniques are used to fabricate drive coils on the bottom surface of a movable member that is coupled to a secondary fixed base member having the secondary set of coils for position sensing, in a ‘flip chip’ configuration. A significantly larger working surface can be obtained on the exposed or upper surface of the movable member using this ‘flip chip’ technique as drive coils need not be fabricated on the same plane as the working surface.

In a further aspect of the present invention, the movable member of the moving coil motor is configured in more than one tier. In one embodiment, the moving coil motor is configured in two tiers, such that the working surface of the movable member is on a first tier and the drive coils are supported on a second tier. This configuration allows the movable member to have a large working surface for a given form factor, or a smaller overall device footprint, which allows configuration of a higher density array of moving coil motors in the same area. Coils for position sensing (e.g., transmitter or receiving coils) may be provided in a third tier, in a three-die construction.

The moving coil motor of the present invention may be configured to support and drive a mirror surface on the movable member to form a galvanometer, optical switch, tunable laser, or variable optical attenuator. A number of moving coil motors may be configured to form an array of optical switches to facilitate switching in a multi-channel optical network. The MEMS based micromirrors are driven to route light signals carrying data in fiber-optic networks. In a fiber optic network, the tiny mirrors can be positioned to block, pass, or reflect (redirect) incoming light beams conveyed via individual strands of optical fiber to receivers (e.g., receiving fibers). Alternatively, the mirrors can be pivoted to direct the incoming light beams at a desired angle to receivers. The moving coil motors may be bulk fabricated to form separate optical switch units to be finally assembled in an array, or an integrated planar array of optical switch units on the same substrate.

### BRIEF DESCRIPTION OF THE DRAWINGS

FIG. 1 is a plan view of a dual axis optical switch assembly incorporating a moving coil motor in accordance with one embodiment of the present invention.

FIG. 2A is a sectional view of the dual axis optical switch assembly taken along line 2A-2A in FIG. 1; FIG. 2B is a sectional view of the dual axis optical switch assembly taken along line 2B-2B in FIG. 1.

FIG. 3 is a sectional view of the dual axis optical switch assembly taken along line 2A-2A in FIG. 1 showing tilting motion of the movable member.

FIG. 4 is a sectional view of a dual axis optical switch assembly incorporating a two-tier moving coil motor in accordance with another embodiment of the present invention.

FIG. 5 is a plan view of a dual axis moving coil motor fabricated for use in an optical switch.

FIG. 6 is a sectional view of the optional three tier design with bonded mirror surface on movable member taken along line 6-6 in FIG. 5.

FIG. 7 shows an array of optical switch assemblies driven by moving coil motors in accordance with the present invention.

FIG. 8 shows an array of optical switch assemblies driven by moving coil motors with alternating north/south permanent magnets in accordance with one embodiment of the present invention.

FIG. 9 shows an array of optical switch assemblies driven by moving coil motors with alternating offset north / south permanent magnets in accordance with another embodiment of the present invention

FIG. 10 shows an array of optical switch assemblies with alternating hexagonally oriented north/south permanent magnets in accordance with another embodiment of the present invention.

FIG. 11 shows an alternate embodiment of a coaxial magnet to provide the axisymmetrical radial field.

FIG. 11a shows an alternate embodiment of the magnetic means using north oriented cylindrical permanent magnets interspersed in a south oriented solid magnetic substrate.

FIG. 12 is a plan view of an alternate spring configuration in accordance with another embodiment of the present invention.

FIG. 13 is a perspective view of a dual axis optical switch assembly in accordance with another embodiment of the present invention.

FIG. 14 is a sectional view of the dual axis optical switch assembly taken along line 14-14 in FIG. 13.

FIG. 15 is a bottom plan view of a dual axis optical switch assembly incorporating a moving coil motor in accordance with another embodiment of the present invention.

FIG. 16 is a plan view of a positing sensor/transmitter coil on the bottom die in FIG. 14 in accordance with another embodiment of the present invention.

### DETAILED DESCRIPTION OF THE PREFERRED EMBODIMENT

This invention is described below in reference to various embodiments and drawings. While this invention is described in terms of the best presently contemplated mode of carrying out the invention, it will be appreciated by those skilled in the art that variations and improvements may be accomplished in view of these teachings without deviating from the scope and spirit of the invention. This description is made for the purpose of illustrating the general principles of the invention and should not be taken in a limiting sense. The scope of the invention is best determined by reference to the appended claims.

By way of illustration and not limitation of the inventive aspects of the moving coil motor of present invention, the present invention will be described below in reference to optical switches, and in particular with reference to optical switches in which a mirror is supported to move in at least two axes, in two or more degrees of freedom. The present invention is applicable to moving coil motors configured for multiple degrees of freedom of motion. The illustrated embodiments are directed to MEMS implementations of the moving coil motor of the present invention. It is understood that the present invention is applicable to moving coil motors in implementations other than MEMS without departing from the scope and spirit of the present invention.

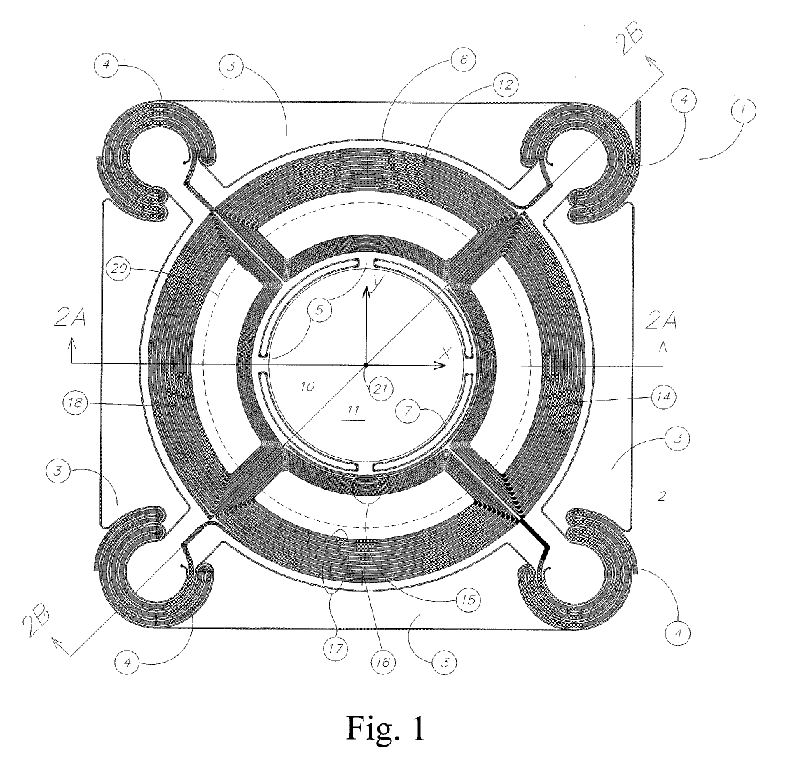

Referring now to FIG. 1, there is shown a plan view of one embodiment of a micromachined structure implementing a dual axis optical switch assembly 1 that incorporates a moving coil motor in accordance with the present invention. In this illustrated embodiment, the material for the micromachined structure is a monocrystalline silicon substrate. The advantages of using such material include desirable mechanical characteristics, such as superior stiffness, durability, deformation and fatigue characteristics, and suitability for attaining optically ‘flat’ surfaces. In addition, monocrystalline silicon substrates are relatively inexpensive, readily available and batch fabrication techniques are well established for such material.

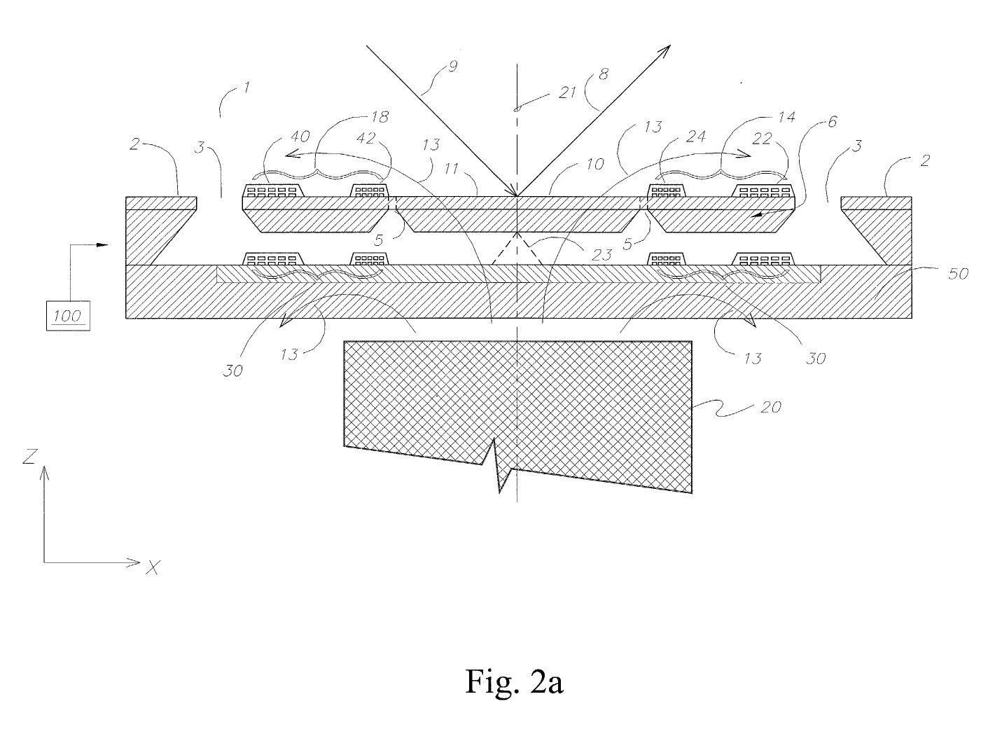

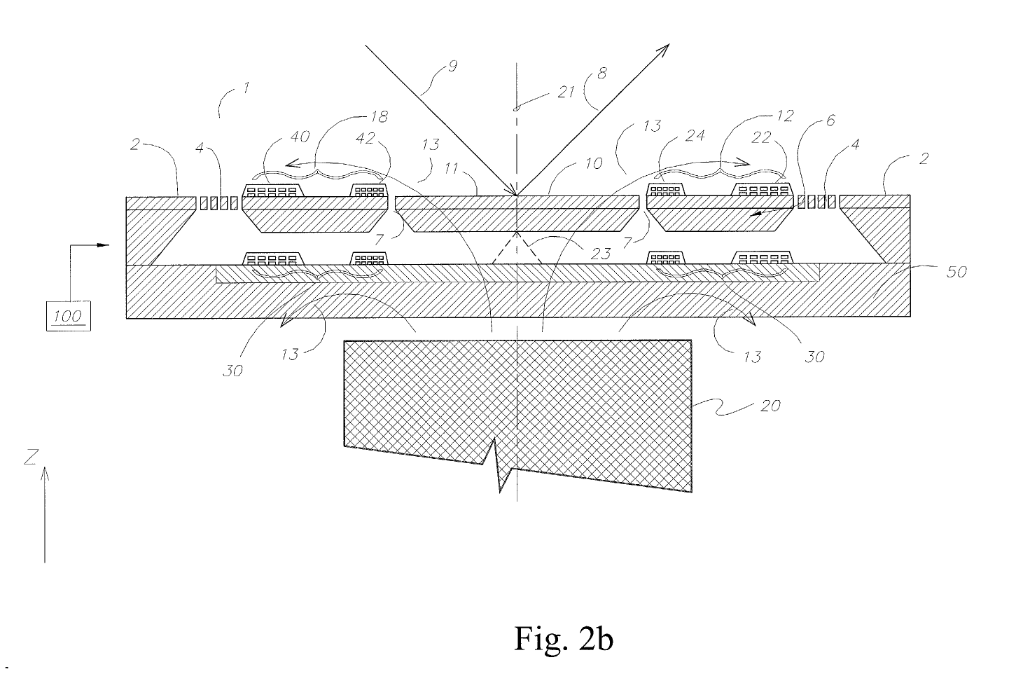

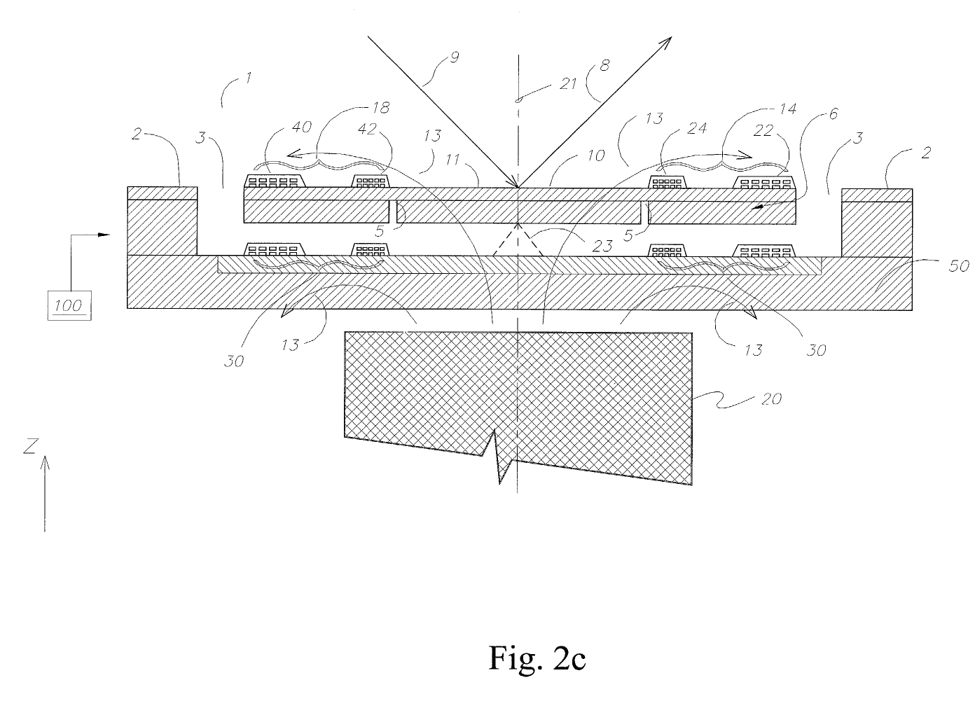

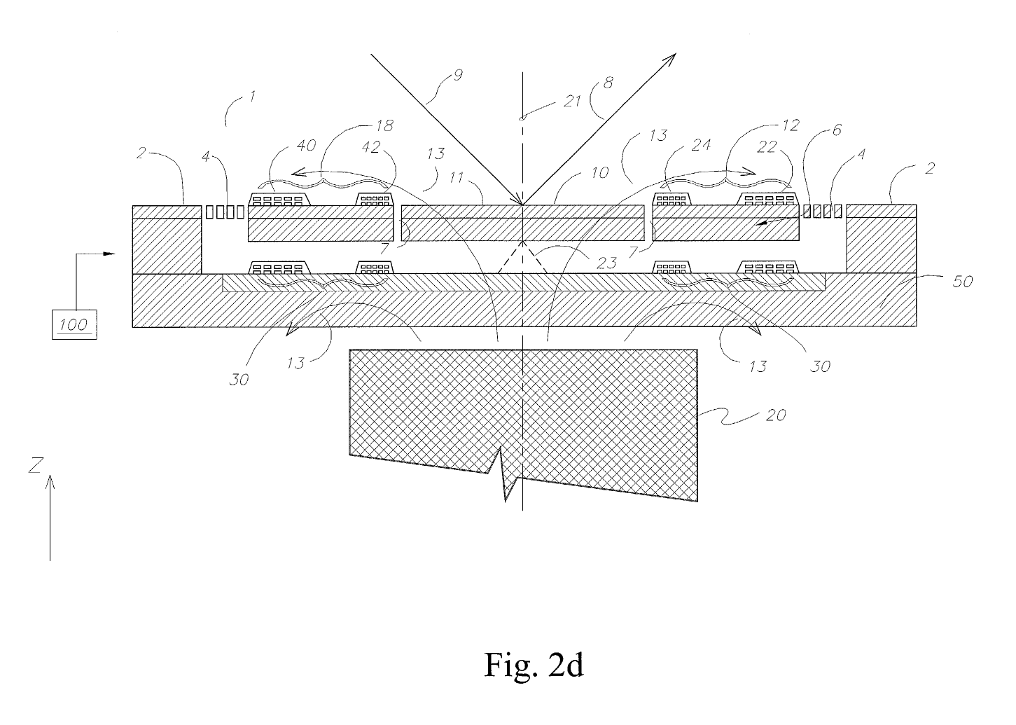

The optical switch assembly 1 illustrated is a dual-die assembly, comprises a movable member 6 supported on a base 50 for tilting motion within a central space 3 defined by a fixed frame 2. (It is contemplated that a single die assembly may be formed with the base 50 omitted, without departing from the scope and spirit of the present invention.) The movable member 6 supports a mirror 10. The movable member 6 also supports drive coils 12, 14, 16 and 18. Referring also to FIGS. 2A and 2B, a permanent magnet 20 is fixedly positioned below the moveable member 6 and mirror 10, such that its magnetic axis is substantially orthogonal to the nominal plane of the movable member 6 (i.e., the plane of FIG. 1), and the movable member 6 (more importantly the region defined by the drive coils) is generally symmetrical with respect to the magnetic axis 21 of the permanent magnet 20. The permanent magnet 20 applies a generally axisymmetric magnetic field 13 to the movable member 6, preferably such that the effective component of the axisymmetric magnetic field is in a generally radial direction with respect to the drive coils. The drive coils (12, 14, 16, 18) are configured such that the current flowing through the drive coils interacts with the axisymmetric magnetic field to tilt the movable member about the nominal plane.

The moving coil motor operates on the principle that when an electrical current is sent through a conductive element in the presence of a magnetic field, a Lorentz force (F) acts on the conductive element. The force F can be determined by the following equation:

F=iL×B

where i is the current vector for the current flowing in the conductive element, L is the length of wire, and B is the magnetic field vector.

An incoming light beam 9 directed at the mirror 10 is reflected and redirected as reflected beam 8 in a direction dictated by the tilt angle. By selectively controlling the tilt angle of the mirror 10, the reflected beam 8 can be directed to a selected receiver in an optical network. The structures and interactions of the various components are described in greater details below.

The movable member 6 of the moving coil motor is supported for tilting motion in the space 3 within the frame 2 by a plurality of suspension springs, such as planar serpentine springs 4, to allow tilt in one or more axes. As shown in FIG. 1, the spring element of a serpentine spring 4 extends (in a cantilevered fashion) from the frame to the movable member 6 in a serpentine pattern. The serpentine springs 4 provide compliance in the out-of-plane (Z) direction, but are relatively stiff in the lateral (X and Y) directions. As an example, the cross-section of the spring is generally rectangular, with ratio of in-plane dimension to thickness of about 8:1 (e.g., 80×10 microns). Another characteristic of the serpentine springs 4 is that they have a small form factor with the spring element configured in a serpentine manner. Given that for a given elasticity constant and a given force, a longer spring element provides a relatively larger displacement compared to a shorter spring element, a serpentine spring produces a small form factor, compliant structure that produces relatively large displacements (e.g., 0.5 mm) under relatively small forces (e.g., 1 mN). The compact nature of the serpentine springs 4 is especially advantageous in a MEMS implementation. Reference is made to U.S. Pat. No. 5,778,513 to Miu et al., which is commonly assigned to the assignee of the present application, and which is fully incorporated by reference herein.

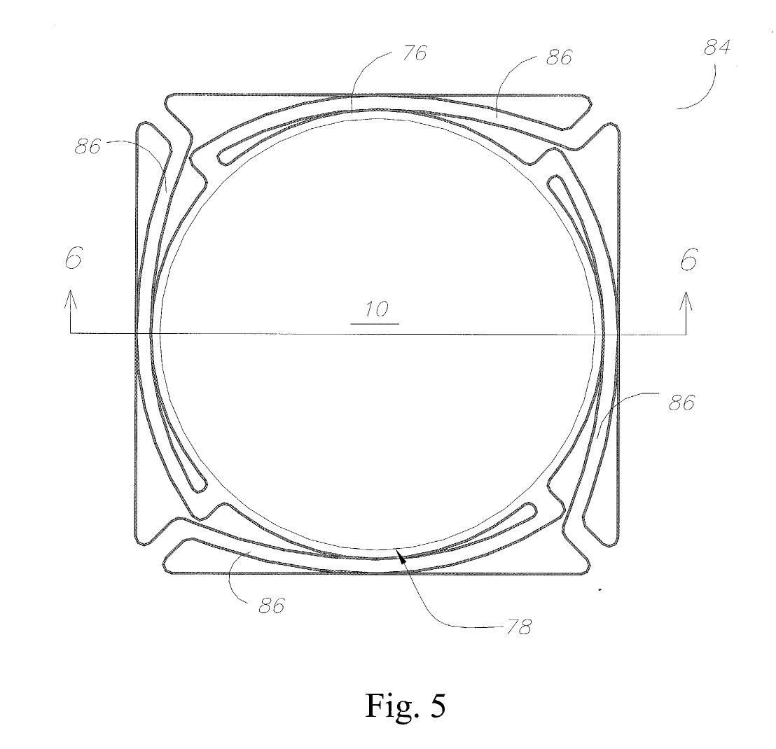

In the illustrated embodiment, the serpentine springs 4 symmetrically support the periphery of the movable member 6 to the frame 2 for tilting movement about the nominal plane of the movable member 6. Although four serpentine springs are shown in the embodiment of FIG. 1, it is understood that different types, spring configurations and numbers of springs may be used for the moving coil motor without departing from the scope and spirit of the invention (for example as shown in FIGS. 5, 12 and 15 and discussed below).

In FIG. 1, the mirror 10 may be a member that is coated (e.g., gold plating) or finished (e.g., by polishing) to form a reflective surface 11. Alternatively, the mirror 10 may be a separate element or a member that supports a separate mirror element. In this embodiment, the mirror 10, though integral to the movable member 6 in the micromachined structure, may be a member separated from the annulus of the movable member 6 by a space gap 7, but coupled to and supported by the annulus of the movable member 6 via thin tethers 5. The thin tethers 5 are pliant, which essentially act as flexible couplings that allow adequate stress isolation to prevent the mirror 10 from warping if the movable member 6 warps as it experiences temperature changes. In one embodiment, there are four tethers, each circumferentially offset with respect to a serpentine spring 4 by 45 degrees. (The number of tethers may be more or less than the present embodiment, or may be omitted in other embodiments disclosed below.)

Planar coils 12, 14, 16 and 18 are placed generally axisymmetrically on the movable member 6, outside of a working surface (in this embodiment a mirror). It is contemplated that other axisymmetrical or asymmetrical coil configurations may be implemented without departing from the scope and spirit of the present invention. Specifically in the embodiment shown in FIG. 1, the annulus surface of the movable member 6 is divided into four equal quadrants, each served by a drive coil. (Other embodiments disclosed below may have a different number of drive coils. The present invention is not limited by the number of drive coils.) The drive coils are positioned with their centerlines in a 45-degree offset with respect to the serpentine springs 4, with each drive coil section supported between two serpentine springs 4. Each drive coil comprises a continuous winding. The drive coils may be connected to a current source (e.g., from the controller 100), such that current flows in diametrically opposing drive coils in opposite directions. For example, when current flow in the drive coil 12 is in a counterclockwise direction and current flow in the drive coil 16 is in a clockwise direction, the moveable member will tilt about the x axis. Similarly, when current flow in the drive coil 14 is in a clockwise direction and current flow in the drive coil 18 is in a counterclockwise direction, the member will tip about the y axis. Each diametric pair of drive coils may be electrically coupled in series. Alternatively, the drive coils may be electrically decoupled so as to allow additional flexibility in individually controlling the current flows in the drive coils to control more degrees of freedom of movement, as explained below.

It is noted that the outer segments 17 of the drive coils are the “working segments,” as they are further from the tilt axis than the inner segments 15 and therefore more effective in providing the torque to tilt the movable member under Lorentz forces. It is further noted that the inner segments 15 of the drive coils work against the outer segments 17 as the current in the inner segments flows in the opposite directions. The inner segments of the drive coils mainly function as a return path for the electrical current. Consequently, it is preferred to position the outer segments 17 as far from the tilt axis, and the inner segments 15 as close to the tilt axis to reduce the moment arm of the inner segments 15. The radial component of magnetic field 13 has a lesser Lorentz force effect on the inner segments 15 than the outer segments 17, partly because the length of the inner segments 15 are shorter than outer segments 17, and partly because the radial component of the magnetic field is smaller at the location of the inner segments 15.

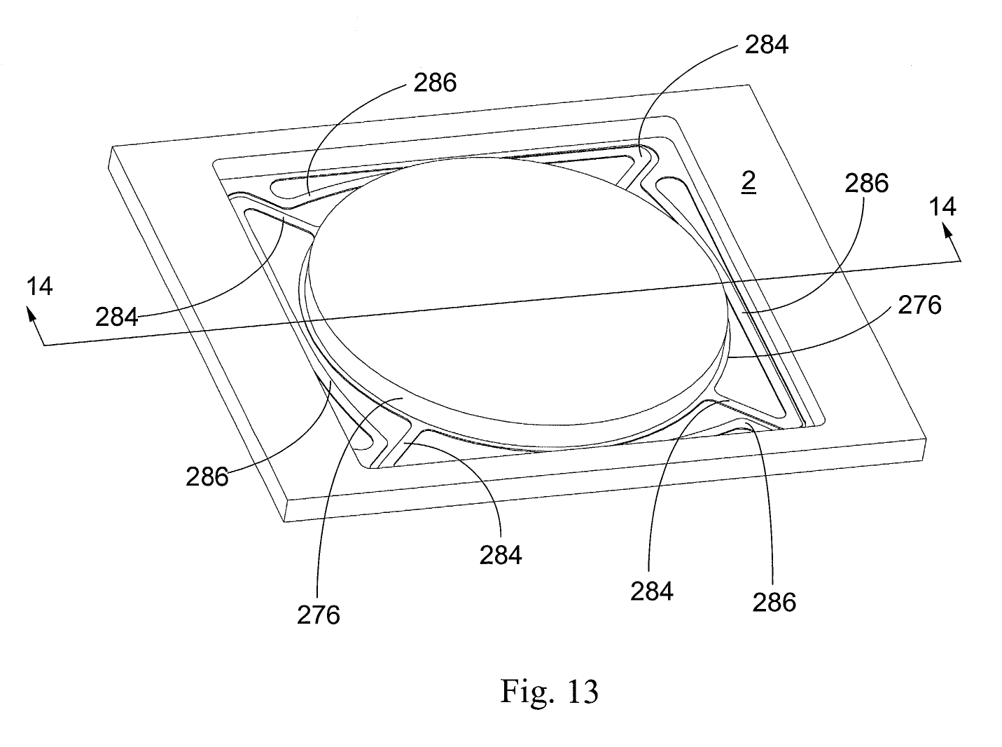

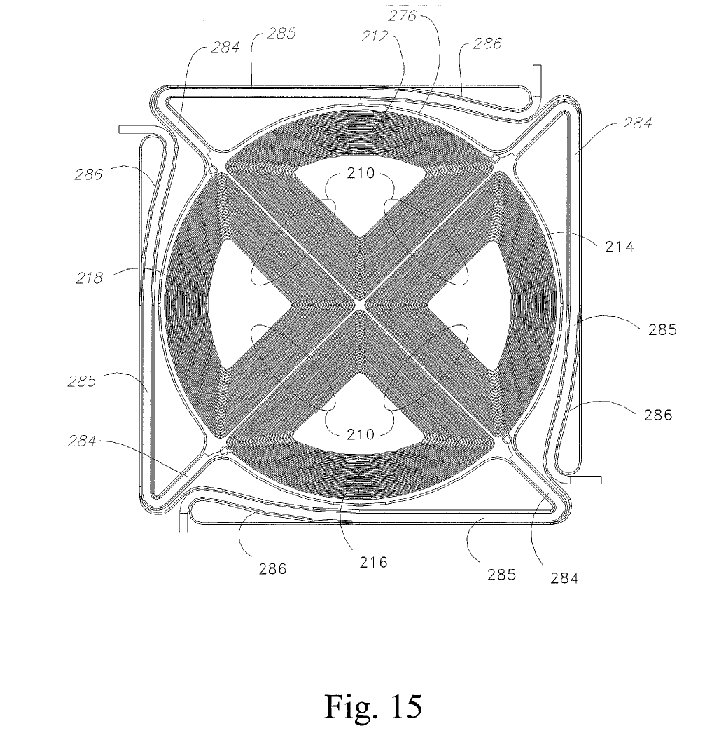

Another drive coil pattern is shown in the embodiment of FIG. 13-15. FIG. 15 is a bottom plan view of the movable member 276 showing the drive coils 212, 214, 216, and 218. A reflective surface on the top of the movable member 276 defines a mirror 10. Since the drive coils are provided on the bottom surface of the movable member 276, the mirror 10 covers a significantly larger area for a movable member of a given size, as compared to the embodiment of FIG. 1. This provides a larger target for an incoming light beam without having to increase the form factor of the moving coil motor and mirror assembly. The drive coils are each in a pie shape covering a sector of the circular area below the movable member, having radial segments 210 that are generally aligned with the radial magnetic field component with respect to the axis 21 of the magnet 20. The radial segments create little or no net Lorentz forces in the presence of the magnetic field.

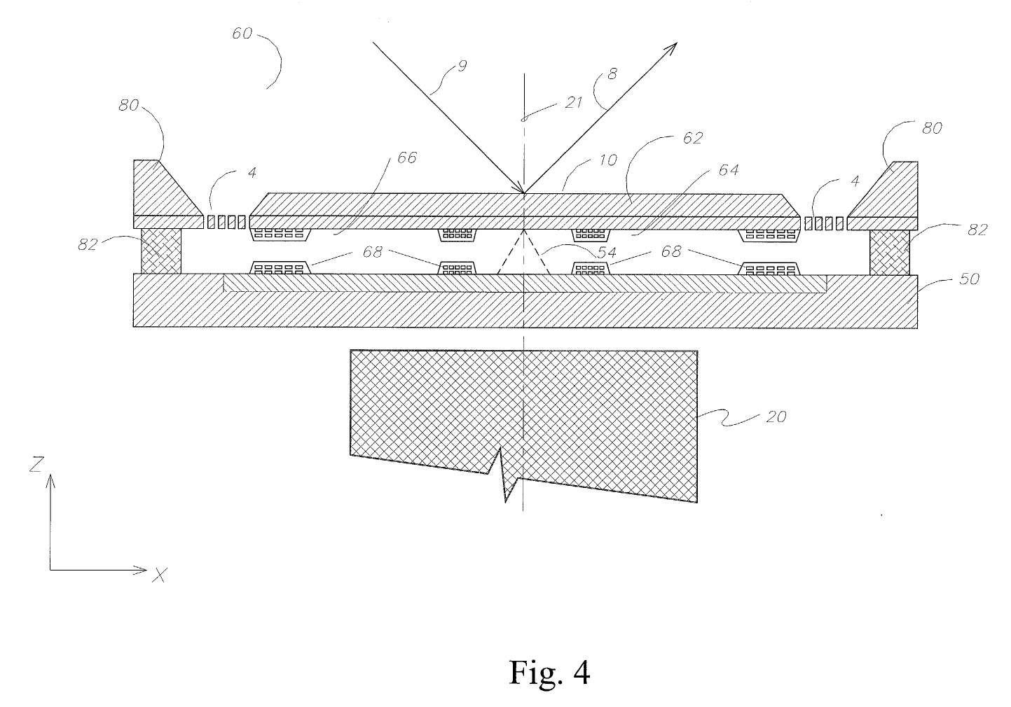

The vertical edges of the movable member 276 are more perpendicularly defined than the angled edges of the movable member 62 in FIG. 4 mainly due to the differing micromachining processing techniques used to fabricate each device. Standard wet chemical etching techniques can be used to fabricate the moving coil motor depicted in FIG. 4. A deep reactive ion etching process, such as the process developed by Bosch, Inc, can be used to fabricate the moving coil motor depicted in FIG. 13. It may be desirable in many situations to use a deep reactive ion etching process to fabricate the moving coil motors as opposed to a wet chemical etching process. The movable member 276 can be relatively thick (e.g., on the order of 500 microns) using reactive ion etching, providing good structural stability and a relatively large working surface for the same device footprint area (eg. the mirror) 10. The suspension spring tethers 286 can be fabricated as relatively thin, flat, generally arcuate sections, cantilevered from the frame 2 and supporting the movable member 276. The tethers may have a sectional width to thickness ratio of about 8:1 (e.g., on the order of 80×10 microns). These thin flat tethers 286 provide a larger width for forming conductive traces 285 for the drive coils (see FIG. 15), and provide a desirable higher in-plane resonance mode for better dynamic control of the movable member. It is noted that many different micromachining processes may be used to fabricate MEMS moving coil motors without departing from the scope and spirit of this invention.

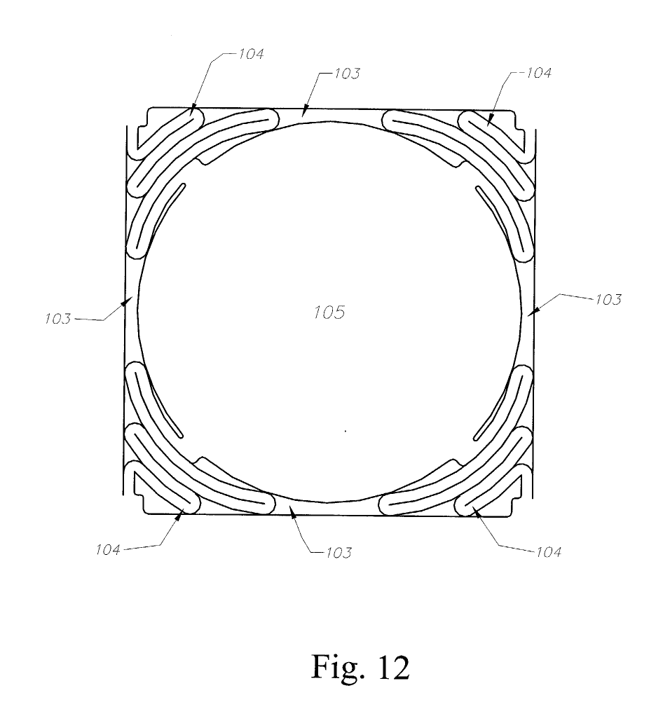

FIG. 12 shows another embodiment in which suspension springs 104 are cantilevered from the frame 2 and supporting the four corners of the movable member 105. Compared to the serpentine springs 4 in FIG. 1, the springs 104 are not wound about in a partially circumferential fashion, but are wound in a zig-zaged fashion. This compact embodiment maintains the long spring element (as in the serpentine springs 4 in FIG. 1) that provides a relatively larger displacement under relatively small forces.

As shown in FIG. 2a, 3, 4, 6, etc, the permanent magnet 20 may be a cylindrical rare earth magnet. (Alternatively, the permanent magnet 20 may be replaced by any permanent magnet—ferromagnetic material or assembly having a remnant magnetic field, or an electromagnet (not shown) without departing from the scope and spirit of the present invention.) The permanent magnet is centered under the movable member 6, with the magnetic axis substantially orthogonal to the nominal plane of the movable member. The end of the permanent magnet 20 is spaced from the movable base 6 such that it does not contact the movable base 6 at the maximum tilt of the movable member 6. The magnetic field 13 from the permanent magnet 20 has a generally axisymmetric and primarily radial field component (with respect to the axis, 21, of the magnet 20), at the location of drive coils (more specifically the outer segments 17), which is the effective component that interacts with the drive coils to create useful torque.

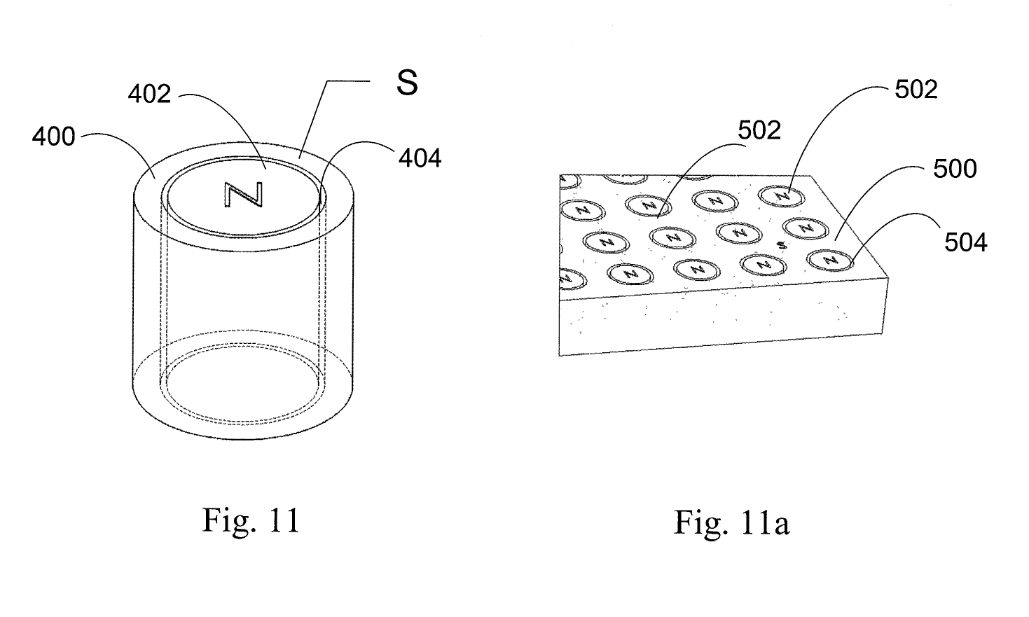

It is within the scope of the present invention to configure the permanent magnet 20 as a combination of magnets that as a whole exhibit strong radial field characteristics. A magnet array may provide higher magnetic field lobes. The objective is to maximize such field lobes for a particular drive coil configuration. There will be an optimal magnetic array design for each coil drive coil configuration. For example, the magnet 20 may comprise an array of smaller magnets. The magnet means 20 may also be configured in the form of two coaxial ferromagnetic materials (at least one having a remnant magnetic field) 400 and 402 separated by air gap 404 (approximately 0.002-0.004 inches wide) with opposing polarities, as shown in FIG. 11

It is also within the scope of the present invention to configure the magnet means 20 as a singular ferromagnetic substrate containing an array of perforations 500 as shown in FIG. 11a. Individual ferromagnetic elements 502 are bonded or fabricated into the perforations, their polar orientations being opposite that of the singular substrate. The ferromagnetic elements 502 are separated from ferromagnetic substrate 500 by air gap 504 in order to maximize radial magnetic field strength at the drive coil. Permanent magnets may be used to accomplish the magnet means shown in FIG. 11a, and in general any configuration where at least one of the ferromagnetic substrate or array of ferromagnetic elements has a remnant magnetic field may be used. Similar to the arrayed approaches discussed earlier using individual magnets, various arrays of perforations and interspersed ferromagnetic elements are possible to maximize the radial magnetic field.

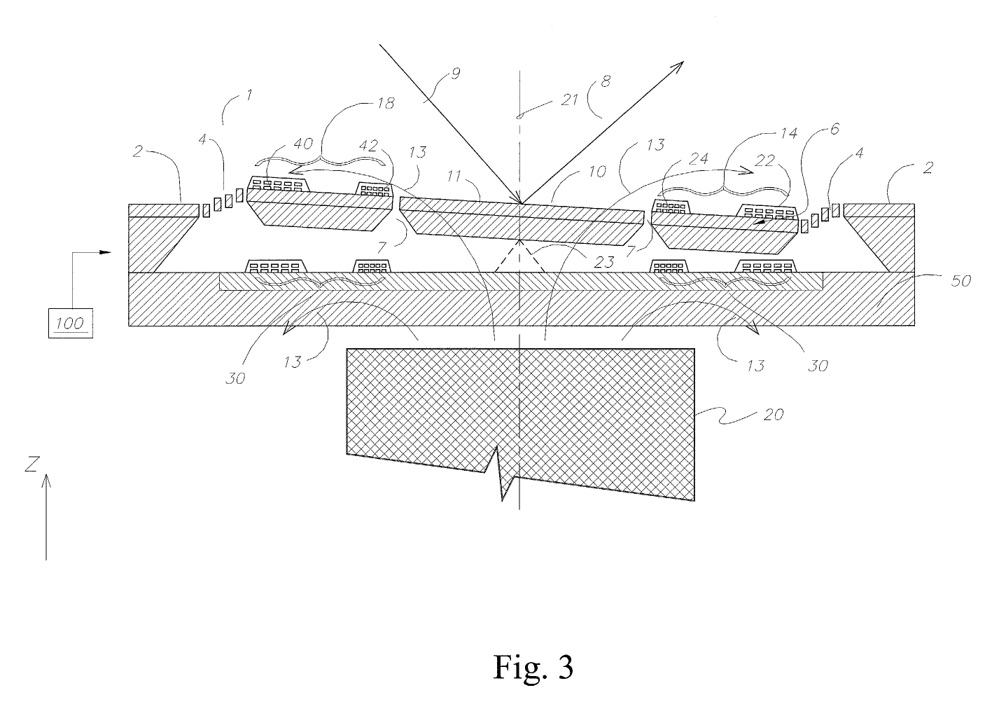

As electrical current is applied selectively and differentially to the drive coils, Lorentz forces created by the interaction of the electric current and the magnetic field of the permanent magnet can tilt the movable member 6 in two degrees of freedom (i.e., the movable member tilts freely to an infinite number of positions about the nominal plane (i.e., X and Y axis)). Specifically, a diametric pair of drive coils can be energized to tilt the movable member 6 about one axis. When two diametric pairs of drive coils are energized, tilting in 2 degrees of freedom is achieved. Referring to FIG. 1, more specifically, the drive coils 14 and 18 are used to tilt the movable member 6 about the Y-axis, and the drive coils 12 and 16 are used to tilt the movable member 6 about the X-axis. When the pair of coils 14 and 18 is energized, electrical current flows through coil 14 in a counterclockwise direction and coil 18 in a clockwise direction. The component of the Lorentz force acting on coil 18 is in the +Z direction, and the component of the Lorentz force acting on coil 14 is in the −Z direction, resulting in tilting of the movable member 6 counterclockwise about the Y-axis as shown in FIG. 3. Reversing the current direction in the coils 14 and 18 would result in tilting in the opposite direction. Similarly, energizing coils 12 and 16 would cause the movable member to tilt about the X-axis in a direction determined by the direction of the current flow through the pair of coils. The combined effect of the two pair of drive coils would tilt the movable member in two degrees of freedom to any position about the nominal plane of the movable member 6. By supporting the movable member 6 using suspension springs 4, the movable member can freely tip and tilt. It is noted that any number of independent coils can be matched to suitable planar magnet arrays to maximize the torques due to the Lorentz forces.

The optical switch may be deployed in an optical cross-connect, such as in the optical cross-connect assembly disclosed in the concurrently filed, co-pending U.S. Provisional Application No. 60/277,047 (attorney docket no. 1017/233), entitled “Optical Cross-Connect Assembly”, filed Mar. 18, 2001 in the names of Dueck et. al, which is commonly assigned to Integrated Micromachines, Inc., the assignee of the present invention. This application is fully incorporated by reference herein.

The controller 100 is configured to provide the necessary control of the operation of the moving coil motor to drive the optical switch assembly. The controller 100 controls the movements and positions of the switch to direct light signals to a desired target receiver, which may be another mirror switch, sensor or optic fiber, in connection with the appropriate protocol. The controller may include a feedback control system for mirror position and movement control, such as the dynamic analog feedback control system disclosed in the concurrently filed, co-pending U.S. Provisional Application No. 60/277,657 (attorney docket no. 1017/226), entitled “Distributive Optical Switching Control System”, filed Mar. 18, 2001 in the names of Evans et. al, which is commonly assigned to Integrated Micromachines, Inc., the assignee of the present invention. This application is fully incorporated by reference herein. The controller may also include a calibration system for optical alignment of the optical switches 25 between the two subassemblies, such as the system disclosed in U.S. Provisional Application No. 60/277,657, filed Mar. 18, 2001 (attorney docket no. 1017/226), which had been fully incorporated by reference herein.

In addition to suspension by the suspension springs 4, the movable member 6 may be supported on a pivot formed on the base 50 and positioned along the magnetic axis of the permanent magnet 20. Referring to FIG. 2A, a pivot 23 may be provided on base 50 above the top face of the magnet 20. The pivot limits the translational movement of the movable member in the −Z direction (towards the magnetic means), such as caused by external shock or vibration to the optical switch assembly 1.

If a pivot is not applied, the movable member 6 may be moved in the Z-direction by individually controlling the current flow direction in the drive coils. For example, by applying current through the coils 14 and 18 in the same direction (e.g., clockwise), the Lorentz forces on both coils would be upwards, so moving the movable member upwards in the +Z direction. Accordingly, by controlling the direction and/or magnitude of the current flow through all four drive coils, it is possible to control tilting movement about X and Y axes, as well as translational movement in the Z-axis, resulting in three degrees of freedom. By controlling all three degrees of freedom it is possible to reject vibrations and external disturbances and compensate for gravitational and other effects that may adversely affect the performance of a device implemented with the moving coil motor.

There are several design variables that may lead to a range of optimization for the performance and efficiency of the moving coil motor. Some of these design variables include the form factor of the moving coil motor, the relative size and geometry of the components, the load on the movable member, the torsional characteristics of the suspension assembly, the value of the control current, the heat dissipation characteristics, the magnetic field characteristics of the permanent magnet, etc. For example, the relative positioning and geometry of the inner segments 15, outer segments 17 and the permanent magnet 20 would affect the efficiency and performance of the moving coil motor. The size and field of the magnet 20 and the geometry of the drive coils affects the Lorentz interaction. The outer segments 17 could be positioned at the point where the net torque is maximized. One could maximize the applied torque at the lowest possible current or lowest power. Lower power consumption in the coils would reduce heat build-up that could otherwise adversely affect structural stability as a result of thermal expansion and induced stresses. The geometry of the structural components and the magnetic field for optimum efficiency and performance can be effectively determined by known computer aided analysis and/or experimentation using parametric analysis by those skilled in the art.

In one embodiment, the overall dimension of the space 3 defined by the frame 2 is on the order of 4 mm square. The movable member 6 is on the order of 0.060 mm thick and 3 mm in diameter. The overall height of the base 50 and frame 2 is on the order of 400 μm. The maximum tilt angle possible with this configuration is about 6 degrees from the nominal plane, under a power of less than 20 mW.

The frame 2, the serpentine springs 4 and the movable member 6 (including the mirror 10, coils 12, 14, 16 and 18, tether 5 and other features thereon) are fabricated using a mono-crystalline silicon structure to improve structural integrity. These features are formed by micromachining from a mono-crystalline silicon substrate using known micromachining and/or semiconductor manufacturing techniques, such as lithography, deposition, chemical and/or plasma etching (e.g., reactive ion etching), and other processes. Reference is made to U.S. Pat. No. 5,778,513, which has been incorporated by reference herein.

In another aspect of the present invention, sensors are provided to detect the relative position (ie. angular displacement) of the movable member 6. Position sensing may be based on eddy current sensing or capacitive sensing. Alternatively, position sensing may be implemented in accordance with linear variable differential transformer (LVDT) principles. For example, position sensing may be implemented using complementary transmitter and receiver coils that are inductively coupled. A high frequency AC signal is sent through the transmitter coil and variations in the voltage drop induced in the receiver coil arising from changes in the relative positions between the transmitter and receiver coils are detected. Many different position sensing configurations are possible so long as inductively coupled coil sets are positioned on both the fixed frame and movable members of moving coil motor. The transmitter coils may be disposed on the movable member and the receiver coils may be disposed on an adjacent fixed member (either the top or the base portion of the fixed frame). Alternatively the receiver coils may be disposed on the movable member and the transmitter coils may be disposed on an adjacent fixed member (either the top or the base portion of the frame). The transmitter coils and receiver coils need not be mirror images of each other in order to provide for effective inductive coupling.

In one embodiment of a dual-die moving coil motor assembly, transmitter coils are fabricated on either the top or base of the movable member. The same coils on the movable member function as both the drive coils for the moving coil motor and the transmitter coils for position sensing. The drive/transmitter coils are inductively coupled to the receiver coils on the fixed frame. A high frequency AC signal is superimposed onto the DC control current to the drive coil. The positions of the movable member are determined based on the detection of the variations in voltage drop induced on the fixed receiver coils arising from changes in the relative positions (and therefore inductive coupling) between the drive/transmitter coils and the receiver coils.

Alternatively, the transmitter coils are positioned on either the top or base member of a fixed frame relative to the drive coils on the movable member. In this embodiment, the coils on the movable member function both as drive coils for the moving coil motor, and receiver coils for position sensing. The high frequency AC signal can be sent through the windings of the transmitter coils, and the drive coils would be used to sense the tilt positions by its induced voltage drop. Due to its high frequency, this AC signal on the drive coil will not interfere with the static actuation or the device dynamics.

For example, in the embodiment illustrated in FIG. 2A, the drive coils 12, 14, 16 and 18 can also function as the position- sensing transmitter coils. The position-sensing receiver coils 30 are positioned in a second tier on the base 50, in relation to the drive coils 12, 14, 16, 18 on the first tier on the movable member 6. A high frequency AC signal is sent through the windings of the drive coils, which is sensed by the position-sensing coils 30. The tilt positions of the movable member 6 are determined based on the detection of the variation in voltage induced in the receiver coils 30 arising from changes in the relative positions between the drive coils 12, 14, 16 and 18, and the respective receiver coils 30. The position sensing may be implemented based on the LVDT position sensor disclosed in the concurrently filed, co-pending U.S. Provisional Application No. 60/277,049 (attorney docket no. 6/088), entitled “Position Sensor And Controller For A MEMS Device And Incorporation Thereof Into An Optical Device”, filed Mar. 18, 2001 in the names of O'Hara et. al, which is commonly assigned to Integrated Micromachines, Inc., the assignee of the present invention. This application is fully incorporated by reference herein.

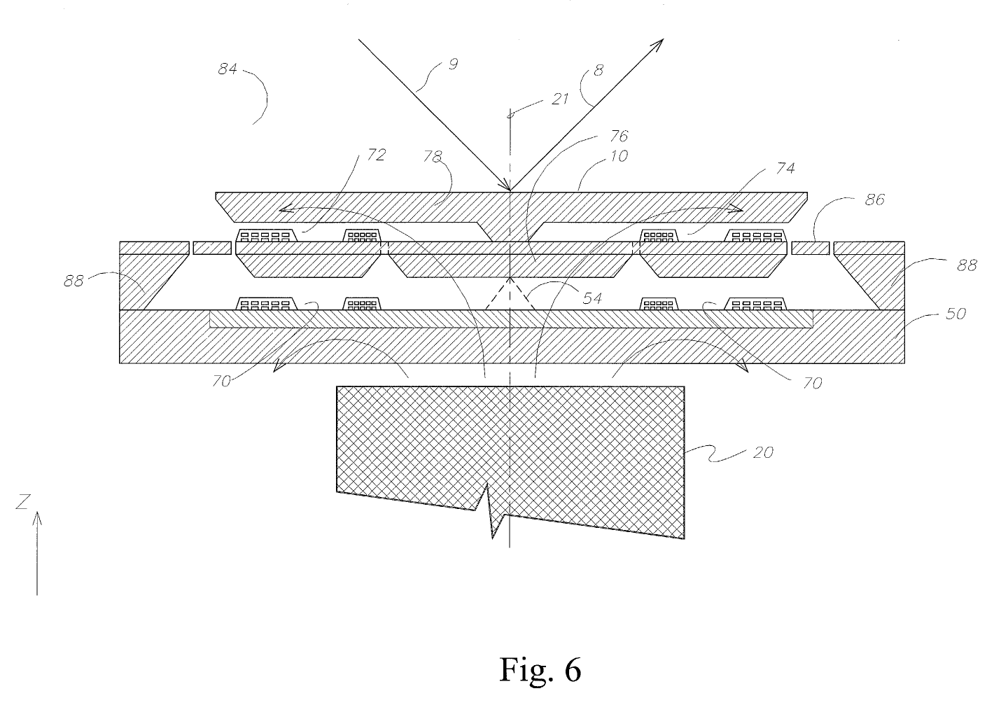

FIG. 4 shows another embodiment of the present invention in which the position sensing transmitter coils (64 and 66) are placed on the underside of movable member 6 of the moving coil motor and the receiver coils 68 are placed on a fixed base substrate 50 Compared to the embodiment in FIG. 3, the movable member 62 is not segmented into a mirror section and an annular coil section. In a further aspect of the present invention, the movable member 62 is configured in more than one tier of working elements. In the embodiment illustrated in FIG. 4, the moving coil motor 60 is configured in two tiers, such that the working surface (i.e., the mirror 10 in this embodiment) of the movable member 62 is on a first tier above the movable member 62 and the drive coils (e.g., coils 64 and 66) (that double as the position-sensing transmitter coils) are on the opposing face of the movable member 62 opposite to the position sensing receiver coils 68 on the base 50. The span of the mirror 10 may be substantially the area of the movable member 62. Similarly in the “three-die” embodiment illustrated in FIG. 6 (to be discussed in greater details below), the drive/transmitter coils (72 and 74 shown in the drawing) are provided at a first tier on the moveable member 76 in relation to position sensing coils 70 on the base 50, and the mirror 10 is on a second tier on the top of a top die 78. The mirror 10 may span substantially the entire area of the top die 78. Both of these configurations allow the movable member to have a smaller overall device width, which allows configuration of a higher density array of moving coil motors within the same area.

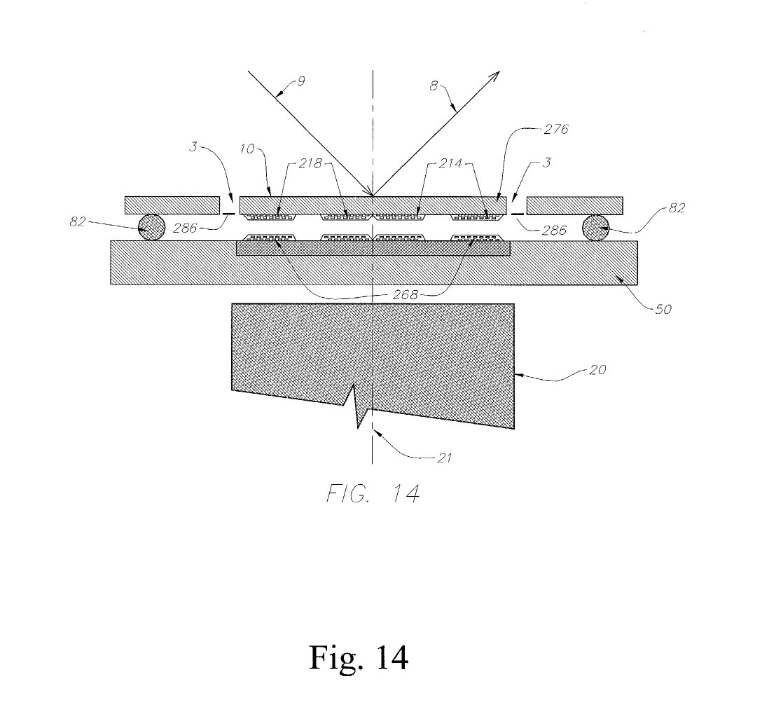

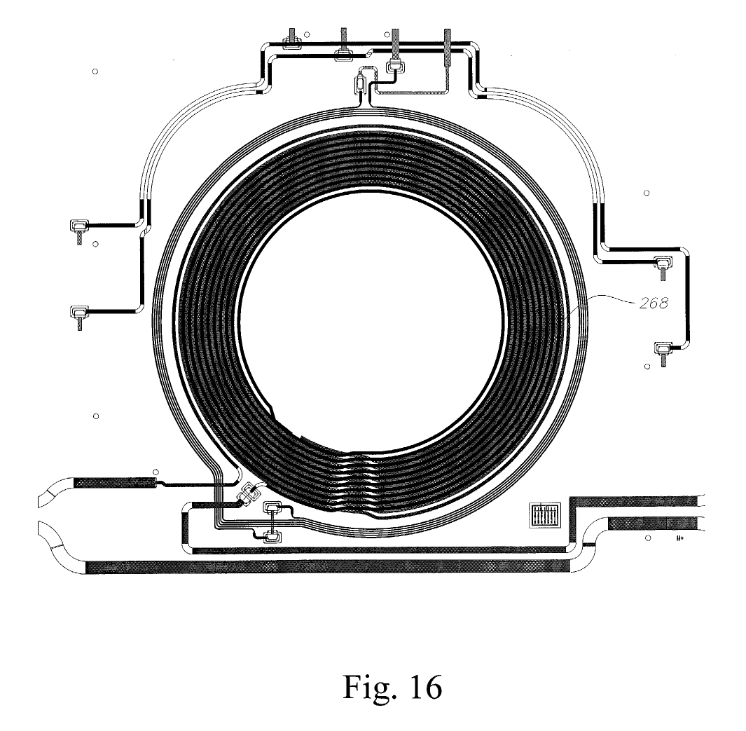

FIGS. 14-16 show an improvement over the embodiment of FIG. 4. In this embodiment, the position-sensing transmitter coil is positioned on a fixed portion of the moving coil motor, and the drive coils of the moving coil motor double as the position-sensing receiver coils. The movable member 276 is configured in a dual-die, “flip-chip” configuration. The working surface (i.e., the mirror 10) is on a first die above a base die 50. Drive coils 212, 214, 216 and 218 are positioned below the movable member 276 and opposite to the coils 268 on the base 50. Drive coils 212, 214, 216 and 218 double as the receiver coils for position sensing, and the transmitter coils 268 carry the high frequency AC signal. In this embodiment, as illustrated in FIG. 16, the transmitter coils 268 form a single circumferential loop that is inductively coupled to the four receiver/drive coils 212, 214, 216 and 218 on the underside of the movable member 276. This embodiment is particularly relevant in high density arrays, providing a static reference point for the high frequency RF signal, and avoiding the possibility of the signals transmitting from the transmitter coils on an adjacent movable member being detected by the fixed receiver coils in neighboring motors, thus potentially interfering with position data.

In all the foregoing embodiments, the position-sensing functions of the coils on the fixed (top or base frame members, or any fixed substrate in an operative distance to the movable member) and movable members (top or underside portion) of the moving coil motor may be interchanged, such that the transmitter coils may be on any fixed member (relative to the movable member) and the receiver coils on the movable member, or vice versa.

In another aspect of the present invention, a “flip-chip” construction is adopted to construct the two-tier embodiment disclosed in FIG. 4. The frame 80 is separated from the base 50, e.g., by solder posts or balls 82. The frame supports the movable member 62 such that the mirror surface 10 is on the top side of the movable member 62 and the drive coils (e.g., 64, 66) are on the underside of the movable member 62. The drive coils may otherwise be of a similar configuration as the embodiment in FIG. 3. FIG. 14 shows another embodiment of a flip-chip configuration.

FIGS. 5 and 6 illustrate the embodiment of a three-die structure for the optical switch assembly 84. In this embodiment, the suspension springs 86 are generally slender arcuate members, extending along the outside of the perimeter of the movable member 76. The suspension springs 86 are cantilevered from the frame 88 and supporting the movable member 76 in a generally S-shaped configuration. This suspension spring configuration provides a higher in plane resonance mode for better dynamic control and simpler dynamic control scheme. Other variations in suspension spring configurations may also be implemented without departing from the scope and spirit of the present invention.

In the embodiment shown in FIG. 6, as mentioned earlier, the mirror 10 is on a top tier 78, which is rigidly supported on the movable member 76, by fusion bonding or solder bonding, for example. The top tier 78 moves in unison with the movable member 76, as actuated under Lorentz forces discussed in connection with the earlier embodiments.

It is noted that the embodiment shown in FIG. 4 may be modified to use the springs 86 instead of serpentine springs. The top view of such an embodiment is generally similar to FIG. 5, with the exception that the top die 78 is not present.

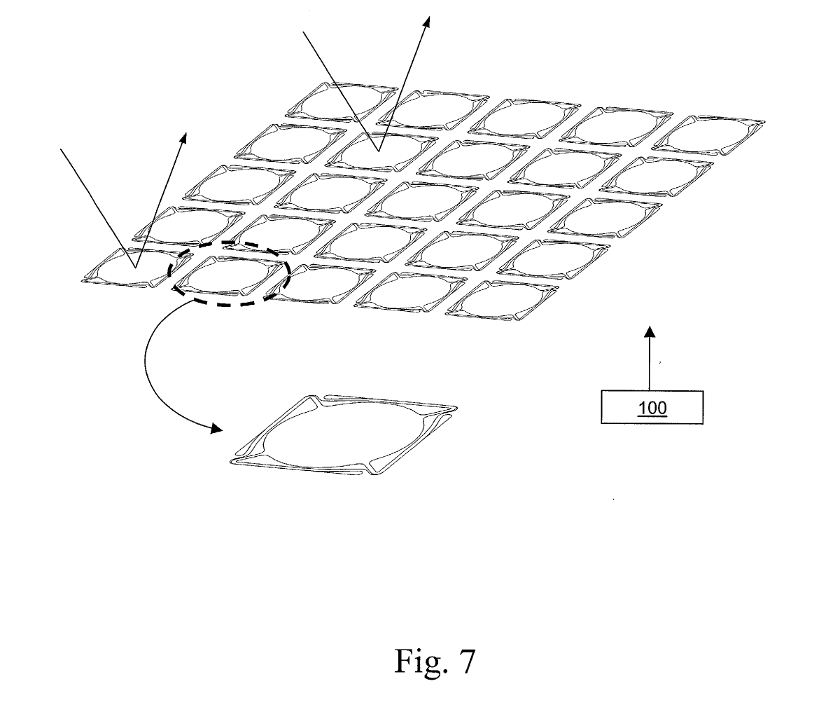

MEMS based moving coil motors may be configured in an array, which may be fabricated from the same substrate or assembled from individual motors. The MEMS based moving coil motor may be bulk fabricated using semiconductor element manufacturing techniques. A number of moving coil motors may be configured to form an array of optical switches (schematically shown in FIG. 7) to facilitate switching in a multi-channel optical network. The moving coil motors may be bulk fabricated to form separate optical switch units to be finally assembled in an array, or an integrated planar array of optical switch units on a same substrate. The MEMS based mirrors can be driven to route light signals carrying data in fiber-optic networks. In a fiber optic network, the tiny mirrors can be positioned to block, pass, or reflect (redirect) incoming light beams conveyed via individual strands of optical fiber to receivers (e.g., receiving fibers). Alternatively, the mirrors can be pivoted to direct the incoming light beams at a desired angle to receivers. An optical cross-connect assembly may be configured to facilitate network switching, such as the system disclosed in copending provisional application no. 60/277,047 (attorney docket no. 1017/233) referenced above, which had been fully incorporated by reference herein.

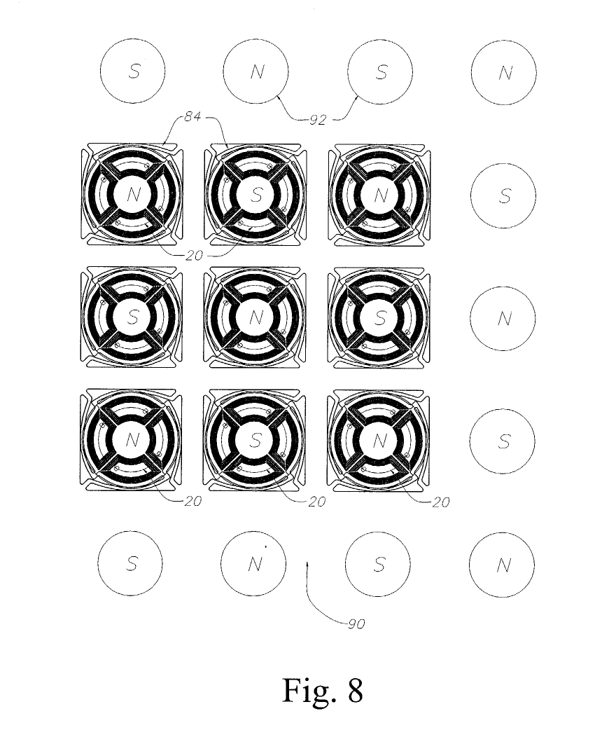

FIGS. 8-10 illustrates the plan view of various embodiments of optical switch arrays. FIG. 8 illustrates an array 90 of switches 84 shown in FIG. 6. The drive coils (Lorentz coils) are shown in FIG. 8 to illustrate the relative positions of the coils and the magnets 20. In this particular array 90, the polarity of the magnets 20 alternates, such that the polarity is opposite between adjacent mirrors. To maintain a generally axisymmetric radial magnetic field for the switches at the edge of the array 90, extra magnets 92 may be provided beyond the edge of the array 90, at the same spacing and grid pattern, with alternating polarity. More than one row of magnets 92 may be required outside the array 90. With the alternating polarity between adjacent magnets, an improved, stronger radial magnetic field is achieved to induce higher Lorentz forces in the switches. Not all the magnets are indicated in the figure, but it is understood that the pattern repeats itself.

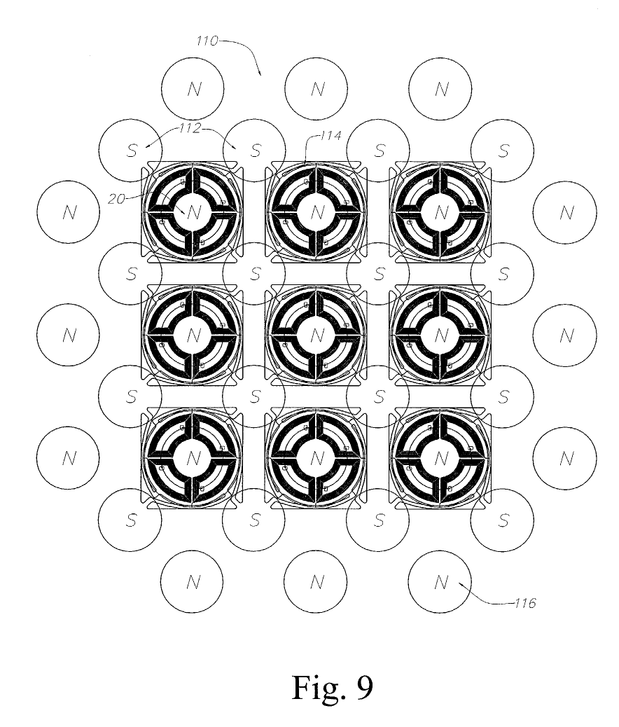

FIG. 9 illustrates an array 110, in which the polarity of the magnets 20 is aligned in the same direction. An array of additional magnets 112 is provided, covering the spacing between switches 114, and having the opposite polarity aligned in the same opposite direction. This alternate embodiment provides another approach to optimizing the performance and size of the switch array and mirrors. Additional magnets 116 may be provided to maintain axisymmetrical radial field for the switches near the edge of the array 110. Not all the magnets are indicated in the figure, but it is understood that the pattern repeats itself.

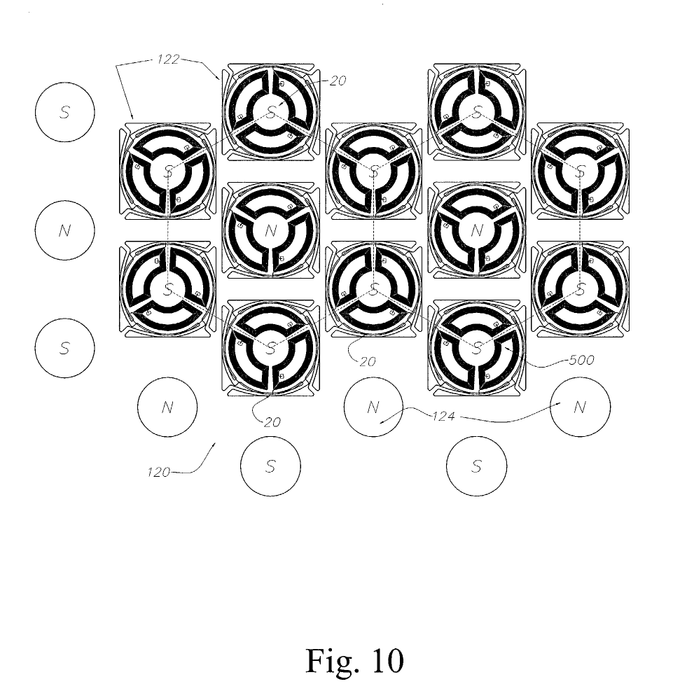

FIG. 10 illustrates another configuration for the switch array. In the array 120, the switches 122 are staggered in a hexagonal pattern in the plane. The polarity of the magnets 20 are aligned in alternating directions. As illustrated, a magnet 20 is surrounded by six magnets of opposite polarity. Additional magnets 124 may be provided to maintain axisymmetrial radial fields for the switches near the edge of the array 120. Not all the magnets are indicated in the figure, but it is understood that the pattern repeats itself. In this embodiment, instead of four drive coils for Lorentz forces, there are three drive coils 500. It is understood that the present invention concept is not limited by the exact number of coils.

A combination of the foregoing magnet array configuration may be implemented to optimize the field and performance and size of the switches.

In the alternate, instead of providing additional magnets at locations that are not under the mirrors, magnetic yokes (such as soft iron or the like) may be provided without departing from the scope and spirit of the present invention.

It is noted that part the hardware and software for feedback control of the switches may be provided with as a component of the switches. For example, the hardware and software may be implemented in an ASIC integral to base 50 of the switch assembly.

The present inventive concepts are also applicable to optical switches and/or attenuators that have one axis of rotation, without departing from the scope and spirit of the present invention. Reference is also made to the embodiments of single axis MEMS devices disclosed in the copending provisional application no. 60/277,049 (attorney docket no. 6/088), which had been fully incorporated by reference hereinabove. Various MEMS-based devices, their fabrication, and their use in optical systems are variously described in the following US Patents, each of which is hereby incorporated by reference as if fully set forth herein: U.S. Pat. No. 6,181,460 to Tran et al; U.S. Pat. No. 5,412,265 to Sickafus; U.S. Pat. No. 5,472,539 to Saia et al; U.S. Pat. No. 5,808,384 to Tabat et al; U.S. Pat. No. 6,094,293 to Yokoyama et al; U.S. Pat. No. 6,166,478 to Yi et al; U.S. Pat. No. 6,124,650 to Bishop et al; U.S. Pat. No. 6,122,149 to Zhang et al; U.S. Pat. No. 6,166,863 to Ahn et al; U.S. Pat. No. 6,087,747 to Dhuler et al; U.S. Pat. No. 5,327,033 to Guckel et al; U.S. Pat. No. 6,144,781 to Goldstein et al; U.S. Pat. No. 6,121,983 to Fork et al; U.S. Pat. No. 5,659,195 to Kaiser et al. MEMS devices and their application to optical systems is described in Office of Naval Research Publication No. NRL/MR/6336-99-7975 dated May 15, 1999, entitled “Optics and MEMS”, authors Steven J. Walker and David J. Nagel. Further, a background reference to MEMS devices may be found in “Silicon As A Mechanical Material”; Proceedings of the IEEE; Vol. 70, No. 5, May 1982, pp. 420-457, author Kurt Peterson. These publications are hereby incorporated by reference as if fully set forth herein.

While the invention has been described with respect to the illustrated embodiments in accordance therewith, it will be apparent to those skilled in the art that various modifications and improvements may be made without departing from the scope and spirit of the invention. For example, the moving coil motor of the present invention may be configured to support and drive a mirror surface on the movable member to form a galvanometer, variable optical attenuator, or tunable laser element. The moving coil motor of the present invention may be configured to drive other MEMS devices. Accordingly, it is to be understood that the invention is not to be limited by the specific illustrated embodiments, but only by the scope of the appended claims.

We claim:

1. A moving coil motor, comprising:
a fixed frame;
a movable member supported by the fixed frame for movement in at least one degree of freedom with respect to a nominal plane;
a magnet means for creating a generally axisymmetrical magnetic field having a magnetic axis substantially orthogonal to the nominal plane of the movable member;
at least one electrically conductive element on the movable member, positioned about the magnetic axis and configured such that current flow through the electrically conductive element interacts with the magnetic field of the magnet means to create Lorentz forces to move the movable member in one or more degrees of freedom.

2. A moving coil motor as in claim 1, wherein the magnetic field of the magnet means includes a generally radial component with respect to the magnetic axis, which acts on the electrical conductive elements.

3. A moving coil motor as in claim 1, wherein the electrical conductive elements are disposed in a generally circumferential symmetry with respect to the magnetic axis of the magnet means.

4. A moving coil motor as in claim 3, wherein the electrically conductive elements include at least one coil configured to interact with the magnetic field to effect tilting movement of the movable member.

5. A moving coil motor as in claim 4, wherein the electrical conductive elements include at least two coils configured to interact with the magnetic field to effect tilting movement of the movable member about at least two axes with respect to the nominal plane of the movable member.

6. A moving coil motor as in claim 5, wherein the electrical conductive elements include first and second pairs of coils, wherein the first pair effects tilting movement of the movable member about a first axis with respect to the nominal plane of the movable member, and the second pair effects tilting movement of the movable member about a second axis with respect to the nominal plane of the movable member.

7. A moving coil motor as in claim 6, wherein the first and second axes are substantially orthogonal to the magnetic axis of the magnetic means.

8. A moving coil motor as in claim 1, wherein the magnet means comprises a ferromagnetic material having a remnant magnetic field, and having a magnetic axis aligned with an axis substantially orthogonal to the nominal plane of the movable member.

9. A moving coil motor as in claim 1, wherein the magnet means comprises a generally cylindrical ferromagnetic assembly having at least one ferromagnetic material with a remnant magnetic field, and having a magnetic axis aligned with an axis substantially orthogonal to the nominal plane of the movable member, the ferromagnetic assembly comprising a first ferromagnetic material along the axis, and a second ferromagnetic material coaxially positioned about the first ferromagnetic material.

10. A moving coil motor as in claim 1, wherein the nominal plane of the movable member is a position in which all the electrical conductive elements are not carrying current.

11. A moving coil motor as in claim 1, wherein the movable member contains a reflective surface.

12. A moving coil motor as in claim 1, wherein the fixed frame comprises one or more parallel oriented support structures for holding the movable member.

13. A moving coil motor as in claim 12, wherein the fixed frame includes parallel oriented top and base support structures.

14. A moving coil motor as in claim 13, wherein the top and base support structures are coupled by a middle spacing member.

15. A moving coil motor as in claim 14, wherein the middle spacing member is a ball grid array.

16. A moving coil motor as in claim 1, wherein the movable member and the fixed frame are fabricated from a monocrystalline substrate.

17. A moving coil motor as in claim 1, wherein the movable member is suspended from the fixed frame by at least one spring coupled to the periphery of the movable member.

18. A moving coil motor as in claim 17, wherein said at least one spring is cantilevered from the fixed frame and supports the movable member.

19. A moving coil motor as in claim 18, wherein said at least one spring is unitary to the fixed frame and movable member.

20. A moving coil motor as in claim 17, wherein there a plurality of springs, and said springs are positioned axisymmetrically about the movable member.

21. A moving coil motor as in claim 20, wherein the fixed frame defines a space in which the movable member is supported by the springs, and each spring is cantilevered from the frame, extending in a slender, generally arcuate fashion.

22. A moving coil motor as in claim 21, wherein the fixed frame defines a generally square space in which the movable member is supported, wherein each spring is cantilevered from substantially a corner of the fixed frame, and wherein each spring extends to support the movable member at a position near an adjacent comer of the fixed frame.

23. A moving coil motor as in claim 1, further comprising position sensing means for sensing spatial position of the movable member.

24. A moving coil motor as in claim 23, wherein the position sensing means comprises means for sensing tip and tilt position based on inductive coupling principles.

25. A moving coil motor as in claim 23, wherein the position sensing means comprises a transmitter coil and a receiver coil, and wherein the transmitter coil is supported on the movable member, and the receiver coil is supported on either the top or base support structure of the fixed frame in an inductively coupled manner.

26. A moving coil motor as in claim 23, wherein the position sensing means comprises a transmitter coil and a receiver coil, and wherein the transmitter coil is supported on either the top or base support structure of the fixed frame in an inductively coupled manner, and the receiver coil is supported on the movable member in an inductively coupled manner.

27. A moving coil motor as in claims 25 or 26, wherein the position sensing means includes means for sending a high frequency AC signal to the transmitter coil and sensing a voltage drop in the receiver coil to determine the position of the movable member.

28. A moving coil motor as in claims 25 or 26, wherein the electrically conductive elements are also configured to function as the transmitter or receiver coil.

29. A moving coil motor as in claim 28, wherein the electrically conductive elements are supported on a side of the movable member that opposes the transmitter or receiver coil on the fixed frame.

30. A moving coil motor as in claim 29, wherein the transmitter or receiver coil supported by the fixed frame is supported on top of the base support structure coupled to the fixed frame, and the electrically conductive elements are supported on the underside of the movable member facing the coil on the base support structure.

31. A moving coil motor as in claim 28, wherein the electrically conductive elements are supported on a top side of the movable member, and the transmitter or receiver coil supported by the fixed frame is supported on the top of the base support structure coupled to the fixed frame, facing an underside of the movable member.

32. A moving coil motor as in claim 31, wherein the receiver or transmitter coil on the base support structure comprises a circumferential coil of electrically conducting elements having a span in operative relationship with the transmitter or receiver coil, respectively, on the movable member.

33. A moving coil motor as in claim 1, further comprising a tier member supported on the movable member, wherein the tier member defines a working surface.

34. A moving coil motor as in claim 33, wherein the working surface is a reflective surface.

35. A moving coil motor as in claim 1, wherein the electrically conductive elements are supported on an underside of the movable member towards the magnetic means, and the movable member comprises a top side defining a working surface.

36. An optical switch for use in an optical network, comprising:
a moving coil motor as defined in claim 1; and
a reflective surface defined on the movable member for receiving an incident light.

37. An optical switch as in claim 36, further comprising control means for controlling movement of the movable member to reflect light at a desired target.

38. An array of moving coil motors, comprising:
a fixed frame;
a plurality of moving coil motors, each comprising:
(a) a movable member supported by the fixed frame for movement in at least one degree of freedom with respect to a nominal plane;
(b) a magnet means for creating a generally axisymmetrical magnetic field having a magnetic axis substantially orthogonal to the nominal plane of the movable member;
(c) a plurality of electrical conductive elements on the movable member, positioned about the magnetic axis and configured such that current flow through the electrical conductive elements interacts with the magnetic field of the magnet means to create Lorentz forces to move the movable member in one or more degrees of freedom.

39. An array of moving coil motors as in claim 38, wherein the magnet means for the moving coil motors comprises a first array of ferromagnetic elements each having a remnant magnetic field, and each having a magnetic axis aligned with an axis substantially orthogonal to the nominal plane of the corresponding movable member.

40. An array of moving coil motors as in claim 39, wherein the array of ferromagnetic elements may be configured using discrete assemblies, or may be interspersed in a solid ferromagnetic substrate in a manner to create a generally radial magnetic field with respect to each of the movable members.

41. An array of moving coil motors as in claim 39, wherein the first array of ferromagnetic elements defines alternating polarity between adjacent elements, in a manner defining a generally radial magnetic field with respect to each of the movable members.

42. An array of moving coil motors as in claim 39, wherein the first array of ferromagnetic elements defines a first polarity for each adjacent element, and the magnet means further comprises a second array of ferromagnetic elements defining a second polarity, each positioned between adjacent elements of the first array in a manner to create a generally radial magnetic field with respect to each of the movable members.

43. An array of moving coil motors as in claim 41, wherein the magnet means further comprises additional ferromagnetic elements positioned beyond the array of moving coil motors so as to maintain axisymmetry of the magnet fields at the moving coil motors near the boundary of the array of the moving coil motors.
